(19) United States
(12) Patent Application Publication
(10) Pub. No.: US 2020/0208688 A1
(43) Pub. Date: Jul. 2, 2020

(54) CLUTCH MECHANISM, IN PARTICULAR FOR A MOTOR VEHICLE

(71) Applicant: VALEO EMBRAYAGES, Amiens (FR)

(72) Inventors: Gilles LEBAS, Amiens (FR); Emmanuel COMMEINE, Amiens (FR)

(73) Assignee: VALEO EMBRAYAGES, Amiens (FR)

(21) Appl. No.: 16/633,035

(22) PCT Filed: Jul. 11, 2018
(86) PCT No.: PCT/FR2018/051740

§ 371 Date: Jan. 22, 2020

(30) Foreign Application Priority Data
Jul. 24, 2017 (FR) 1757005

(51) Int. Cl. F16D 13/46; F16D 13/75; F16F 15/123; F16F 15/14

(52) U.S. Cl. CPC F16D 13/46; F16D 13/757; F16D 2300/22; F16F 15/1234; F16F 15/145; F16F 15/12353

(57) ABSTRACT

A clutch device including a reaction plate, a pressure plate, at least two friction disks coupled to an output component by means of damping device, the damping device including an annular web, guide washers, at least one resilient component mounted between the guide washers and the annular web, a first support rotationally coupled to the friction disks and to the guide washers, at least one of the guide washers and the first support being formed by a single support and guide part.

The present invention relates to a clutch device, in particular for a motor vehicle.

It is known for a clutch device to be used that comprises a reaction plate, a pressure plate that can move along an axis relative to the reaction plate between a declutched position and a clutched position, at least two friction disks, each friction disk being capable of being rotationally coupled to the reaction plate in the clutched position of the pressure plate and of being rotationally decoupled from the reaction plate in the declutched position of the pressure plate. The friction disks are coupled to an output component by means of damping means. The damping means comprise an annular web rotationally coupled to the output component, guide washers axially located on either side of the annular web, with at least one resilient component being mounted between the guide washers and the annular web, and a first support rotationally coupled to the friction disks and to the guide washers.

The use of a plurality of friction disks allows the torque to be increased that can be transferred through the clutch device, i.e. from the reaction plate to the output component. The damping means allow vibrations to be limited and the rotational acyclisms of the engine to be dampened.

A requirement exists for further simplifying the structure of such a damping device.

To this end, the invention proposes a clutch device comprising a reaction plate, a pressure plate that can move along an axis relative to the reaction plate between a declutched position and a clutched position, at least two friction disks, each friction disk being capable of being rotationally coupled to the reaction plate in the clutched position of the pressure plate and of being rotationally decoupled from the reaction plate in the declutched position of the pressure plate, the friction disks being coupled to an output component by means of damping means, the damping means comprising an annular web rotationally coupled to the output component, guide washers axially located on either side of the annular web, with at least one resilient component being mounted between the guide washers and the annular web, a first support rotationally coupled to the friction disks and to the guide washers, characterized in that at least one of the guide washers and the first support are formed by a single support and guide part.

Thus, the number of parts and the assembly of the device is limited. This particularly allows the cost of such a device to be reduced without affecting its operation.

The support and guide part can comprise an axially extending part forming the first support and a radially extending part forming the guide washer, the first support being radially located on the outside of the guide washers.

The guide washers can be fixed to each other, for example, by welding or by riveting.

At least one of the guide washers can comprise an axially extending link zone, fixed to the opposite guide washer, the first support radially extending on the outside of the link zone, said first support being at least partly axially positioned facing said link zone.

The first support can comprise grooves capable of engaging with grooves or a tooth of the friction disks, so as to allow axial displacement of the friction disks relative to the first support.

The clutch device can comprise pendulum damping means.

Such damping means allow the filtering and the damping of the vibrations and the rotational acyclisms to be further improved.

The pendulum damping means comprise a second support rotationally coupled to the guide washers, with pendulum masses being movably mounted on the second support.

The pendulum masses can be radially mounted on the outside of the resilient component.

The damping means can comprise at least one first and one second resilient component arranged in series between the annular web and the guide washers, by means of a phasing component.

The device can comprise a diaphragm, which can move between a clutched position and a declutched position, capable of activating the movement of the pressure plate, means for detecting and compensating for wear in the friction disks, which means are interposed between the diaphragm and the pressure plate.

The detection and compensation means can comprise:
means for compensating for wear in the friction disks, which means are interposed between the diaphragm and the pressure plate, said wear compensation means comprising at least one compensation component that can move within a determined range and comprising a ramp engaging with a counter-ramp secured to the pressure plate, so as to adjust the distance between the diaphragm and the pressure plate and to compensate for any wear in the friction disks as a function of the position of the ramp relative to the counter-ramp;
   wear detection means capable of allowing the movement of said compensation component in the event of any wear in the friction disks and capable of preventing such a movement when said wear is not sufficient, said detection means comprising at least one detection component that can move, within a determined range, relative to the compensation component and that comprises a ramp engaging with a counter-ramp secured to the pressure plate;
at least one pressure component forcing at least the ramp of the detection component against the associated counter-ramp, the pressure component being capable of engaging with a fixed stop so as to release said movable components when wear is detected in the friction disks, the movable compensation component being urged so as to move when said movable compensation component is released by the diaphragm, the movable detection component being urged so as to move and to at least partly compensate for the play between said component and the pressure component, when said movable detection component is released by the pressure component and by the diaphragm.

The diaphragm can release the movable detection component and prevent the movement of the movable compensation component, in the fully clutched position, with the diaphragm being capable of releasing the movable compensation component and of preventing the movement of the movable detection component, in the fully declutched position, with the diaphragm always coming into abutment on at least one of said movable components between its fully clutched and fully declutched positions.

The clutch device according to the invention can also comprise one or more of the following features:
the annular web and the output component can be formed as a single part;
the part forming a support axially extends toward the pressure plate from the part forming a guide washer;
the output component is a hub, for example, a hub comprising internal grooves;
the first support comprises grooves engaging with matching grooves of the friction disks, so as to allow axial movement of the friction disks relative to the first support;
each friction disk comprises two friction linings mounted on either side of a third support rotationally coupled to the first support;
a secondary movable plate is axially located between the friction disks, the secondary plate being rotationally coupled to the reaction plate, said secondary plate being translationally axially movable relative to the reaction plate;
one of the friction disks is intended to be clamped between the reaction plate and the secondary plate, the other friction disk being intended to be clamped between the pressure plate and the secondary plate, in the clutched position;
the friction disks, the pressure plate, the guide washers, the first support, the second support and/or the movable plate are annular and coaxial;
the phasing component is formed by two parts, for example, two plates, secured to each other and mounted on either side of the annular web;
the resilient component comprises at least one helical compression spring, for example, a curved spring or a straight spring;
each resilient component comprises two coaxial helical springs;
the damping means comprise friction means;
the friction means are capable of generating a friction torque or hysteresis during the angular displacement between the annular web and the guide washers;
the friction means comprise at least one washer that is resiliently deformable in the axial direction, axially interposed between the annular web and at least one of the guide washers;
the annular web and the phasing component comprise at least one circular arc opening intended to house the resilient component;
the annular web, the phasing component, the guide washers and/or the second support are pivotally mounted around the output component;
the device comprises a cover secured to the reaction plate;
the cover is fixed to the reaction plate by screwing or riveting;
the cover comprises a part axially extending from the reaction plate and a part radially extending from the axial part;
the diaphragm is tiltably mounted around a bearing zone of the cover;
said bearing zone is located in the radial part of the cover.

The invention will be better understood, and further details, features and advantages of the invention will become apparent, upon reading the following description, which is provided by way of a non-limiting example, with reference to the accompanying drawings, in which:

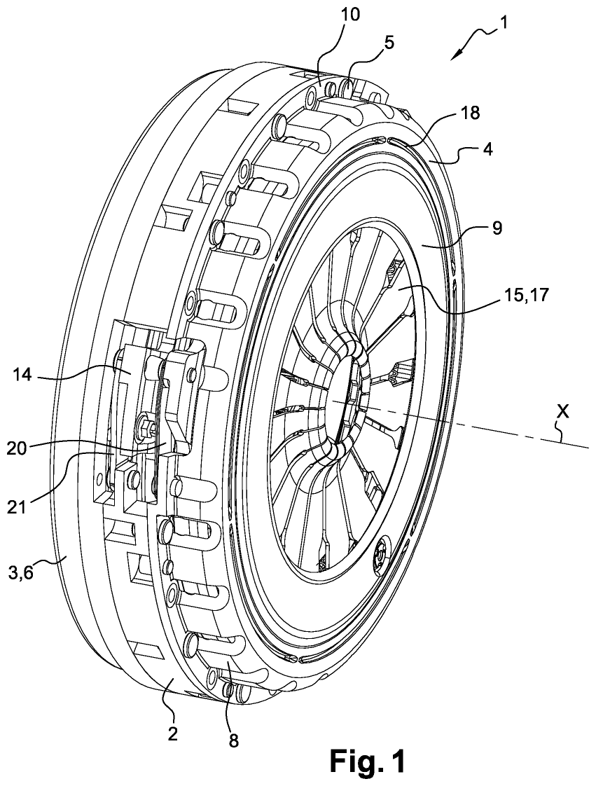

FIG. 1 is a perspective view of a clutch device according to a first embodiment of the invention;

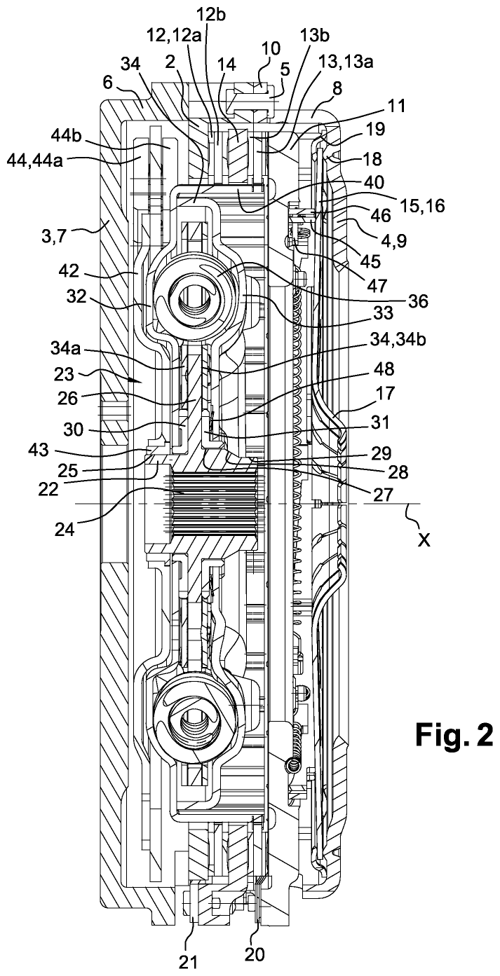

FIG. 2 is an axial section view of the device;

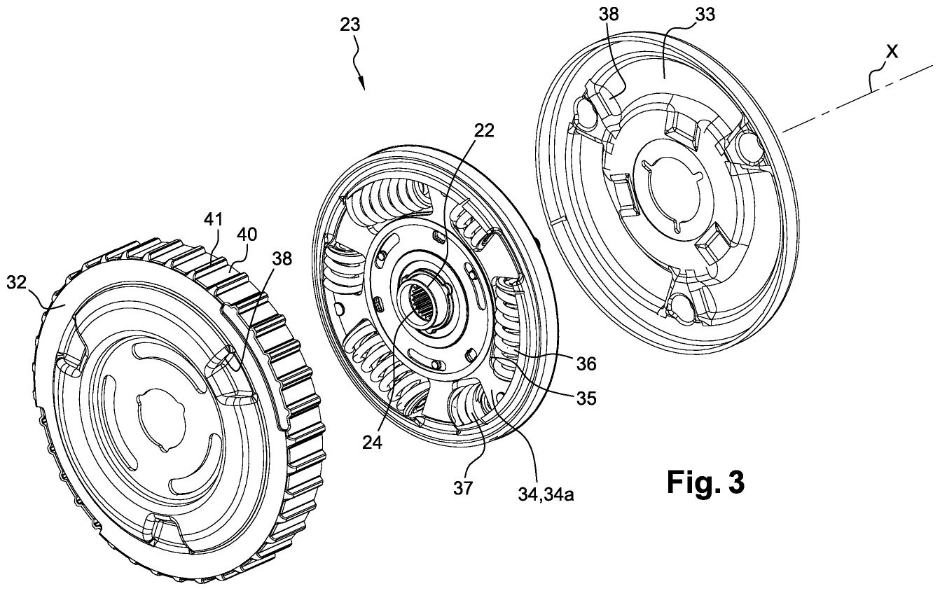

FIG. 3 is an exploded perspective view of part of the device;

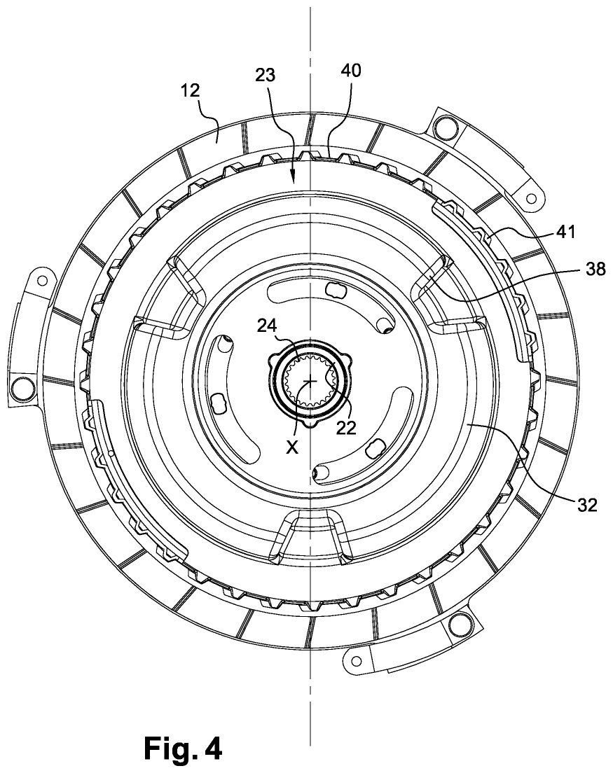

FIG. 4 is a front view of the elements shown in FIG. 3;

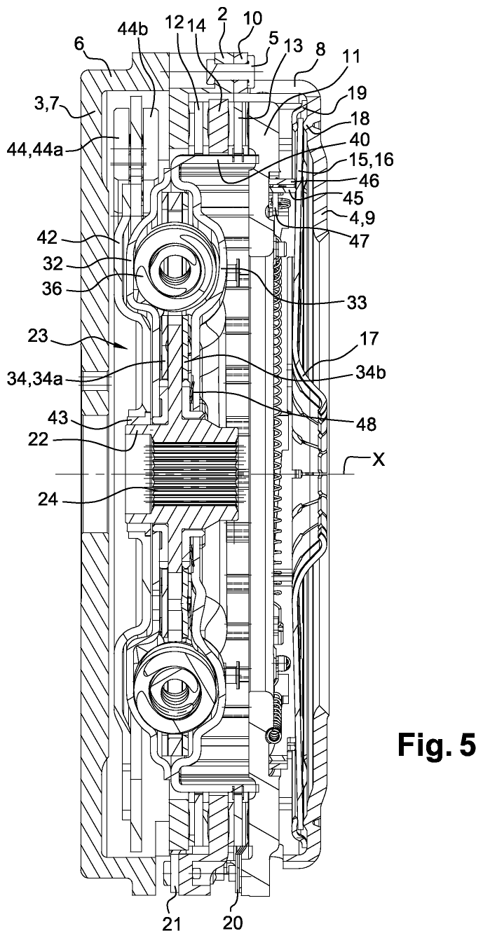

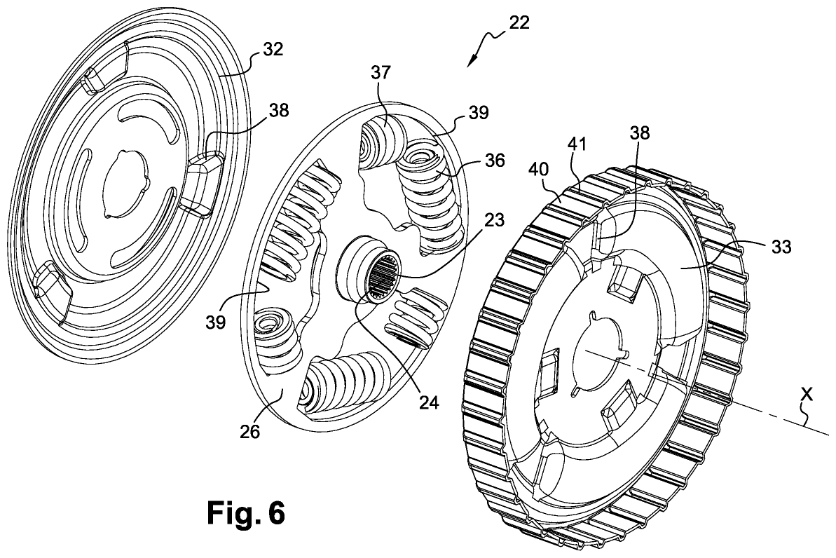

FIGS. 5 and 6 are views respectively corresponding to FIGS. 2 and 3, showing a second embodiment of the invention.

FIGS. 1 to 4 show a clutch device 1 for a motor vehicle according to a first embodiment of the invention. Said device comprises an annular reaction plate 2 with an axis X, a cover 3, called rear cover, secured to the reaction plate 2, and a cover 4, called front cover, opposite the rear cover 3 and fixed to the reaction plate 2 by means of rivets 5. The covers 3 are fixed at the radially external periphery of the reaction plate 2.

The rear cover 3 is annular and comprises a part 6 axially extending toward the rear and a part 7 radially extending toward the inside from the rear end of the axial part 6. The radially internal periphery of the radial part 7 of the rear cover 3 is intended to be secured to a crankshaft of a heat engine of the vehicle, for example.

The front cover 4 is annular and comprises a part 8 axially extending toward the front and a radial part 9 radially extending toward the inside from the front end of the axial part 8. The rear end of the axial part 8 forms a rim 10 radially extending toward the rear, which rim is used to fix the front cover 4 onto the reaction plate 2, in this case by means of rivets 5.

The clutch device 1 further comprises an annular pressure plate 11 that can move along the axis X relative to the reaction plate 2. Two friction disks 12, 13 are axially interposed between the pressure plate and the reaction plate 2.

In particular, a first friction disk 12, or rear friction disk 12, is interposed between a front radial face of the pressure plate 11 and a rear radial face of a secondary reaction plate 14. The secondary plate 14 is axially movable relative to the reaction plate 2 and is rotationally coupled relative to the reaction plate 2. A second friction disk 13, or front friction disk 13, is interposed between a front radial face of the secondary plate 14 and a rear radial face of the pressure plate 11.

Each friction disk 12, 13 comprises an annular support 12a, 13a, with friction linings 12b, 13b being fixed on either side of said support.

The device 1 further comprises a diaphragm 15 comprising a deformable annular part 16, like a Belleville washer, from which activation fingers 17 radially extend toward the inside. The radially internal periphery of the fingers 17 is capable of engaging with a clutch stop, as is per se known. The diaphragm 15 is mounted in abutment on the front cover 4, at bearing zones 18. The bearing zones 18 are distributed over the circumference and are formed by zones projecting from the radial annular part 9 of the front cover 4.

The diaphragm 15 is centered, for example, by means of studs or rivets fixed on the radial part 9 of the cover 4.

The diaphragm 15 is held in abutment on said bearing zones 18 of the front cover 4 by means of a bearing component, in this case formed by a resiliently deformable washer 19 in the axial direction that is fixed to the front cover 4, so as to exert a return force on the diaphragm 15 that tends to hold it in abutment on the bearing zones 18 of the cover 4.

The diaphragm 15 is used to activate the pressure plate 11 between a fully clutched position, in which said pressure plate 11 is pushed toward the reaction plate 2, so as to clamp the friction disks 12, 13 between said plates 2, 14, 11, and a declutched position, in which said pressure plate 11 and the secondary plate 14 are separated from the reaction plate 2 so as to release the friction disks 12, 13. To this end, resilient tabs 20 capable of exerting an axial force connect the front cover 4 and the pressure plate 11. Other resilient tabs 21 capable of exerting an axial force connect the secondary plate 14 and the reaction plate 2. The tabs 20, 21 are arranged so as to resiliently return the pressure plate 11 and the secondary plate 14 to its declutched position. The tabs 20, 21 also provide rotational coupling between the front cover 4 and the reaction plate 2, on the one hand, and the pressure plate 11 and the secondary plate 14, on the other hand.

Such a clutch device 1 is of the normally open type, i.e. it is in the declutched position when the clutch stop does not exert a force or exerts a limited force on the fingers 17 of the diaphragm 15.

The friction disks 12, 13 are rotationally coupled to a torque output component 22 by means of damping means 23.

The torque output component is formed by a central hub 22 with an axis X, the radially internal periphery of which hub comprises grooves 24 intended to engage with matching grooves of an input shaft of a gearbox.

The external periphery of the hub 22 comprises, from the rear to the front, a cylindrical part 25, an annular web 26 radially extending toward the outside, a cylindrical part 27, a frustoconical part 28 narrowing toward the front, and a cylindrical part 29.

A rear ring 30 and a front ring 31, with an L-shaped section, are respectively mounted around cylindrical zones 25 and 27 of the hub 22.

A rear guide washer 32 and a front guide washer 33 are pivotally axially mounted around the rear 30 and front 31 rings on either side of the annular web 26. The front guide washer 33 comprises a rim 34 axially extending toward the rear on the radially external periphery, the rear end of said rim 34 being fixed, for example, by welding or riveting, to the rear guide washer 32. The two guide washers 32, 33 are thus secured to each other.

The damping means 23 further comprise a phasing component 34 comprising two radially extending parts 34a, 34b, which are in the form of annular plates secured to each other, axially located on either side of the annular web 26. The annular web 26 and the plates 34a, 34b of the phasing component 34 comprise openings 35 in the form of an arc (FIG. 3), evenly distributed over the circumference, used for the assembly of resilient components 36, 37. The resilient components 36, 37 are distributed in pairs. A first resilient component 36 of each pair is intended to come into abutment, at a first end, on bearing surfaces 38 of the guide washers 32, 33 and, at a second end, on a corresponding edge of an opening 35 of each plate 34a, 34b of the phasing component 34. A second resilient component 37 of each pair is intended to come into abutment, at a first end, on a corresponding edge of each plate 34a, 34b of the phasing component 34 and, at a second end, on a corresponding edge of an opening 39 of the annular web 26.

The resilient components 36, 37 are helical compression springs, for example, straight or curved springs. Each resilient component 36, 37 can comprise two coaxial springs.

In this way, during the displacement of the guide washers 32, 33 relative to the annular web 26, the first resilient component 36 and the second resilient component 37 of each pair are simultaneously deformed by means of the phasing component 34, so as to oppose the displacement of the guide washers 32, 33 relative to the annular web 26 from a rest position.

In the first embodiment, the rear guide washer 32 is extended at its radially external periphery by an axially extending annular support 40, comprising axially extending grooves 41. Said grooves 41 engage with a matching shaped tooth arranged on the radially internal periphery of the supports 12a, 13a of the friction disks 12, 13.

The friction disks 12, 13 are thus rotationally coupled to the support 40 and to the guide washers 32, 33, whilst being axially movable relative to said support 40.

The damping means further comprise a resilient conical washer 48, which is deformable in the axial direction and is in the form of a Belleville washer. The washer 48 is axially interposed between the front ring 31 and the guide washer 33. Said washer 48 is capable of generating a friction torque or hysteresis during the angular displacement between the annular web 26 and the guide washers 32, 33.

The damping means 23 further comprise an annular support 42, the radially internal periphery of which is mounted around a ring 43, which is mounted around the cylindrical part 25 of the hub 24. Pendulum masses 44 are movably mounted on the radially external periphery of the support 42. Each pendulum mass 44 particularly comprises two parts 44a, 44b secured to each other and located on either side of the support 42. The structure of such pendulum masses and their assembly on an annular support by means of rolling elements is particularly known from document FR 3031369 in the name of the Applicant.

Means for detecting and compensating for wear are axially interposed between the pressure plate 11 and the diaphragm 17. More specifically, the diaphragm 17 engages with said wear detection and compensation means in a zone radially located inside the bearing zones 18 of said diaphragm 17 on the front cover 4.

The detection and compensation means comprise a compensation component 45 that can move within a determined range and that comprises a ramp engaging with a counter-ramp of the pressure plate 11, so as to adjust the distance between the diaphragm 17 and the pressure plate 11 and to compensate for any wear in the friction disks 12, 13 as a function of the position of the ramp relative to the counter-ramp. The detection and compensation means further comprise wear detection means capable of allowing said compensation component 45 to move in the event of any wear in the friction disks 12, 13 and capable of preventing such a movement when this wear is not sufficient. The detection means particularly comprise a detection component 46 that can move, within a determined range, relative to the compensation component 45 and that comprises a ramp engaging with a counter-ramp secured to the pressure plate 11.

A pressure component 47 forces at least the ramp of the detection component 46 against the associated counter-ramp, the pressure component 47 being capable of engaging with a fixed stop so as to release said movable components 45, 46 when wear is detected in the friction disks 12, 13. The compensation component 45 is urged so as to move when said compensation component 45 is released by the diaphragm 17. Furthermore, the detection component 46 is urged so as to move and to at least partly compensate for the play between said component and the pressure component 47, when said detection component 46 is released by the pressure component 47 and by the diaphragm 17.

Such wear detection and compensation means have a similar structure to that disclosed in document FR 3009592 in the name of the Applicant.

FIGS. 5 and 6 show a second embodiment of the invention, which differs from that described in FIGS. 1 to 4 in that the axial part forming a support 40 is not connected to the rear guide washer 32, but is connected to the front guide washer 33. The axial part forming a support 40 thus axially extends toward the front from the external periphery of the radial part forming the front guide washer 33.

The two guide washers 32, 33 are connected together at a plane axially located facing the annular web 26.

In any case, one of the guide washers 32, 33 and the support 40 form the one and the same part, which allows the production and assembly complexity, as well as the cost, of the clutch device 1 to be reduced.

Furthermore, the use of a plurality of friction disks 12, 13 allows the torque that can be transferred through the clutch device 1, i.e. from the reaction plate 2 to the internal hub 24, to be increased.

1-10. (canceled)

11. A clutch device, comprising:
a reaction plate,
a pressure plate that can move along an axis relative to the reaction plate between a declutched position and a clutched position,
at least two friction disks, each friction disk configured to be rotationally coupled to the reaction plate in the clutched position of the pressure plate and to be rotationally decoupled from the reaction plate in the declutched position of the pressure plate, the friction disks being coupled to an output component by a damping means,
the damping means comprising an annular web rotationally coupled to the output component, guide washers axially located on either side of the annular web, with at least one resilient component being mounted between the guide washers and the annular web, a first support rotationally coupled to the friction disks and to the guide washers,
wherein at least one of the guide washers and the first support are formed by a single support and guide part.

12. The clutch device of claim 11, wherein
the support and guide part comprises an axially extending part forming the first support and a radially extending part forming the guide washer, the first support being radially located on the outside of the guide washers.

13. The clutch device of claim 11, wherein
the guide washers are fixed to each other, for example, by welding or by riveting.

14. The clutch device of claim 11, wherein
at least one of the guide washers comprises an axially extending link zone, fixed to the opposite guide washer, the first support radially extending on the outside of the link zone, said first support being at least partly axially positioned facing said link zone.

15. The clutch device of claim 11, wherein
the first support comprises grooves configured to engage with grooves or a tooth of the friction disks, so as to allow axial movement of the friction disks relative to the first support.

16. The clutch device of claim 11, further comprising:
a pendulum damping means.

17. The clutch device of claim 16, wherein
the pendulum damping means comprises a second support rotationally coupled to the guide washers, with pendulum masses being movably mounted on the second support.

18. The clutch device of claim 11, wherein
the damping means comprises at least one first and one second resilient component arranged in series between the annular web and the guide washers, by a phasing component.

19. The clutch device of claim 11, further comprising:
a diaphragm, which can move between a clutched position and a declutched position, configured to activate the movement of the pressure plate, means for detecting and compensating for wear in the friction disks interposed between the diaphragm and the pressure plate.

20. The clutch device of claim 19, wherein
the detection and compensation means comprises
means for compensating for wear in the friction disks interposed between the diaphragm and the pressure plate, said wear compensation means comprising at least one compensation component that can move within a determined range and comprising a ramp engaging with a counter-ramp secured to the pressure plate, so as to adjust the distance between the diaphragm and the pressure plate and to compensate for any wear in the friction disks as a function of the position of the ramp relative to the counter-ramp,
wear detection means configured to allow the movement of said compensation component in the event of any wear in the friction disks and configured to prevent such a movement when said wear is not sufficient, said detection means comprising at least one detection component that can move, within a determined range, relative to the compensation component and that comprises a ramp engaging with a counter-ramp secured to the pressure plate, and
at least one pressure component forcing at least the ramp of the detection component against the associated counter-ramp, the pressure component configured to engage with a fixed stop so as to release said movable components when wear is detected in the friction disks, wherein
the movable compensation component is urged so as to move when said movable compensation component is released by the diaphragm, and
the movable detection component is urged so as to move and to at least partly compensate for the play between said component and the pressure component, when said movable detection component is released by the pressure component and by the diaphragm.
